(19) United States
(12) Patent Application Publication
(10) Pub. No.: US 2025/0289244 A1
(43) Pub. Date: Sep. 18, 2025

(54) PRINTING APPARATUS, METHOD FOR CONTROLLING PRINTING APPARATUS, AND STORAGE MEDIUM

(71) Applicant: CANON KABUSHIKI KAISHA, Tokyo (JP)

(72) Inventors: YUHEI OIKAWA, Kanagawa (JP); YOSHIAKI MURAYAMA, Tokyo (JP)

(21) Appl. No.: 19/074,155

(22) Filed: Mar. 7, 2025

(30) Foreign Application Priority Data
Mar. 14, 2024 (JP) 2024-040233

(51) Int. Cl. B41J 3/46; B41J 2/165

(52) U.S. Cl. CPC B41J 3/46; B41J 2/16535; B41J 2002/16594

(57) ABSTRACT

It is an object of the present disclosure to realize a recovery process that prevents reduced lifetime of a printing head. One embodiment of the present invention is a printing apparatus including: a printing head having an ejection port for ejecting a liquid and a printing element for generating energy required to eject the liquid; a recovery processing unit for recovering the ejection state of the printing head; and a transition unit for causing a recovery process by the recovery processing unit to transition to an executable state, based on estimation information for estimating the ejection state.

### BACKGROUND

### Field

The present disclosure relates to a printing apparatus, a method for controlling a printing apparatus, and a storage medium.

### Description of the Related Art

In a printing apparatus of the related art, an image is formed on a printing medium by conveying the printing medium and ejecting ink droplets from ejection ports of a printing head toward the printing medium. Methods for generating energy to eject ink from the ejection ports of the printing head include a method of pressurizing ink using an electromechanical conversion element such as a piezoelectric element and a method of generating heat by irradiating electromagnetic waves such as a laser to generate bubbles and using the pressure of the bubbles. There is also a method of generating bubbles by heating the ink using an electrothermal conversion element (hereinafter referred to as a “heater”) having a heating resistor.

In a printing head using this heater, heating of the ink by the heater can cause scorching of the ink on the surface thereof, leading to a significant change in ink ejection speed. Many of the inks used for such a printing head are dye-based or pigment-based inks, and many colorants of such inks are insoluble or poorly soluble in water. Therefore, insoluble or poorly soluble substances are scorched onto the heater described above, causing ejection characteristics to change easily.

However, it is known that continuous use of ink that is prone to scorching causes kogation on the heater, resulting in a significant change in the ejection characteristics (for example, reduction in the ejection speed). This change in the ejection characteristics may cause image impairment, such as thin lines, distorted characters, and changes in color due to landing position deviation.

To address this image impairment, Japanese Patent Laid-Open No. 2012-101557 discloses a head having an upper protective layer disposed in a region including a heat acting portion of a heater so as to be electrically connectable to serve as an electrode for causing an electrochemical reaction with ink. This upper protective layer is formed of a material that contains a metal that dissolves due to the electrochemical reaction and does not form an oxide film that prevents the dissolution when heated. This allows the electrochemical reaction to occur and dissolve the surface layer of the upper protective layer. This makes it possible to remove the kogation on the heat acting portion. This process is called a kogation removal process.

### SUMMARY

However, in Japanese Patent Laid-Open No. 2012-101557, the surface layer of the upper protective layer is dissolved every time the kogation removal process is performed. For this reason, the number of times the kogation removal process can be performed is limited by the thickness of the layer that forms the upper protective layer. Therefore, when a configuration is adopted in which a user can perform the kogation removal process at any time, there is a possibility that the lifetime of the printing head gets shorter than expected if the user performs the kogation removal process at an inappropriate time.

In view of the above problem, it is an object of the present disclosure to realize a recovery process that prevents the reduced lifetime of the printing head.

One embodiment of the present invention is a printing apparatus including: a printing head having an ejection port for ejecting a liquid and a printing element for generating energy required to eject the liquid; a recovery processing unit for recovering an ejection state of the printing head; and a transition unit for causing a recovery process by the recovery processing unit to transition to an executable state, based on estimation information for estimating the ejection state.

Further features of the present invention will become apparent from the following description of exemplary embodiments with reference to the attached drawings.

### BRIEF DESCRIPTION OF THE DRAWINGS

FIG. 1 is a schematic diagram showing an overview configuration of a printing apparatus;

FIG. 2 is a block diagram showing an overview of a control system of the printing apparatus;

FIG. 3 is a detailed block diagram of a printer control unit;

FIGS. 4A, 4B, and 4C are diagrams showing a structure of a printing head;

FIG. 5 is a diagram explaining a standby period position and a maintenance position of the printing head;

FIGS. 6A and 6B are diagrams showing a cap tray of the printing apparatus;

FIGS. 7A and 7B are diagrams showing a maintenance tray of the printing apparatus;

FIGS. 8A to 8C are diagrams explaining a maintenance operation for the printing head;

FIGS. 9A and 9B are diagrams showing a structure of a heat acting portion in a printing element substrate of the printing head;

FIG. 10 is a flowchart of a control flow according to a first embodiment;

FIGS. 11A and 11B are diagrams showing screen transitions of a GUI screen displayed on an operation panel of the printing apparatus;

FIGS. 12A and 12B are diagrams showing screen transitions of a GUI screen displayed on the operation panel of the printing apparatus;

FIG. 13 is a diagram showing a screen transition of a GUI screen displayed on the operation panel of the printing apparatus;

FIGS. 14A and 14B are diagrams showing screen transitions of a GUI screen displayed on the operation panel of the printing apparatus; and

FIG. 15 is a diagram showing screen transitions of a GUI screen displayed on the operation panel of the printing apparatus.

### DESCRIPTION OF THE EMBODIMENTS

Hereinafter, preferred embodiments of the present disclosure will be described in detail with reference to the accompanying drawings. Note that the following embodiments are not intended to limit the technical ideas related to the present disclosure more than necessary. Moreover, all the features described in the following embodiments are not necessarily essential means for solving the problems related to the present disclosure. Furthermore, the following embodiments will be described taking an inkjet printing apparatus (hereinafter simply referred to as a printing apparatus) as an example.

### First Embodiment

### Configuration of Printing Apparatus

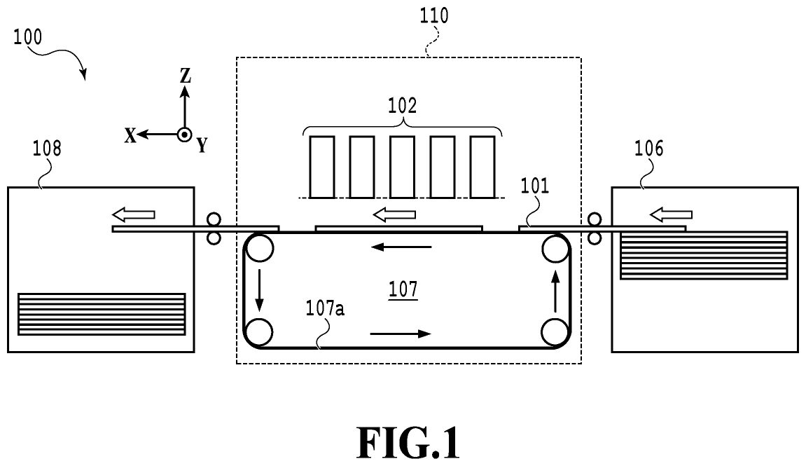

FIG. 1 is a schematic diagram showing an overview configuration of a printing apparatus 100. The printing apparatus 100 is a sheet-fed printing apparatus that produces a printed product by forming an ink image on a printing medium 101 using two types of liquids, a processing liquid and an ink. In the present embodiment, an X direction corresponds to a width direction (overall length direction) of the printing apparatus 100, a Y direction corresponds to a depth direction of the printing apparatus 100, and a Z direction corresponds to a height direction (gravitational direction) of the printing apparatus 100. In this example, since the printing medium 101 is conveyed in the X direction, the X direction also corresponds to a conveyance direction of the printing medium, and the Y direction also corresponds to a width direction of the printing medium.

As shown in FIG. 1, the printing apparatus 100 includes a conveyance unit 107 that conveys the printing medium 101, a feeding unit 106 that feeds the printing medium 101 to the conveyance unit 107, and a discharge unit 108 that collects the printed printing medium 101 from the conveyance unit 107. The printing apparatus 100 also includes a first printing head that applies the processing liquid that reacts with the ink onto the printing medium 101, and a second printing head that forms an ink image by applying the ink onto the printing medium 101 with the processing liquid applied thereto. The first and second printing heads are collectively referred to simply as printing heads 102. The conveyance unit 107 may have units (not shown) having functions such as drying, fixing, cooling, and paper inversion added thereto at any positions depending on a system.

### Control System

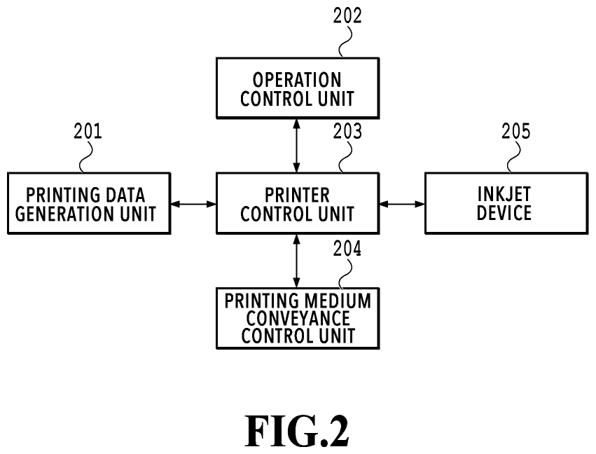

FIG. 2 is a block diagram showing an overview of a control system that controls the printing apparatus 100. This control system includes, as components, a printing data generation unit 201, an operation control unit 202, a printer control unit 203, a printing medium conveyance control unit 204, and an inkjet device 205. The printing data generation unit 201 is a module that generates printing data, and sends the generated printing data to the printer control unit 203. The printing data generation unit 201 may be provided in the printing apparatus 100 or may be configured by an external print server or the like.

The operation control unit 202 is a module that is operated by a user or service person and receives instructions from the user or service person. Specifically, the operation control unit 202 includes an operation panel provided in the printing apparatus 100 and an operation PC connected to the printing apparatus 100. In the present embodiment, the operation control unit 202 will be described as the operation panel. The printer control unit 203 is a module that executes a printing process. The printing medium conveyance control unit 204 is a module for conveying the printing medium. The inkjet device 205 is a module used for printing. The following description will be given taking a case where the user operates the operation control unit 202 as an example, but the service person may also operate the operation control unit 202.

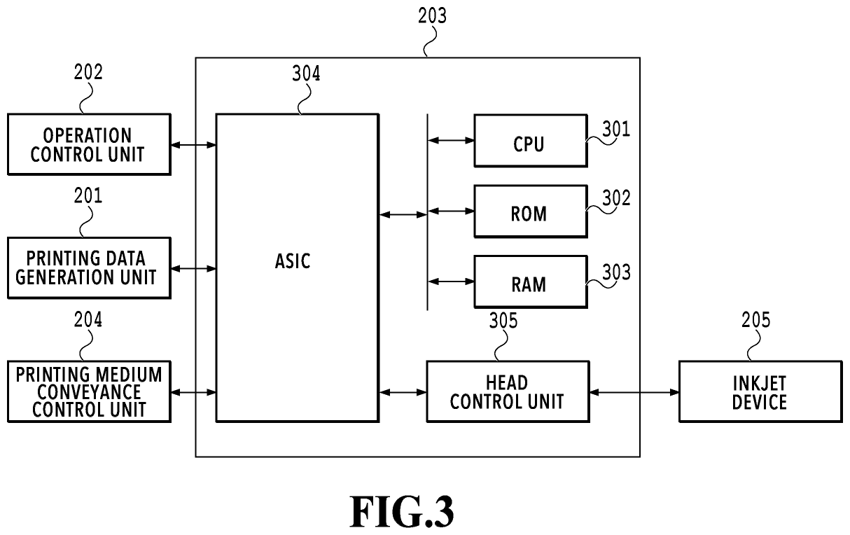

FIG. 3 is a detailed block diagram of the printer control unit 203. FIG. 3 also includes the other components shown in FIG. 2. The printer control unit 203 includes a CPU 301, a ROM 302, a RAM 303, an ASIC 304, and a head control unit 305. The CPU 301 controls the entire printing apparatus 100. The ROM 302 stores a control program of the CPU 301, and the like. The RAM 303 temporarily stores data and is used as a work memory when executing a program. The ASIC 304 is an integrated circuit for a specific application, including a network controller, a serial IF controller, a head data generation controller, a motor controller, and the like. The head control unit 305 generates ejection data used by the inkjet device 205 and generates a drive voltage.

### Conveyance Unit

The conveyance unit 107 in the printing unit 110 will be described below with reference to FIG. 1. In the printing unit 110, the printing head 102 ejects a liquid from above in the gravitational direction onto the printing medium 101 being conveyed. This ejection operation causes a printing process to form an image. The conveyance unit 107 in the printing unit 110 is provided with a horizontal conveyance belt 107a to obtain stable conveyance behavior of the printing medium directly below the printing head 102. The printing medium 101 sent from the feeding unit 106 is conveyed in the +X direction by the conveyor belt 107a while being suctioned in the −Z direction.

The type of the printing medium 101 is not particularly limited, and any known printing medium can be used. The printing medium 101 can be a sheet cut to a specified size, or a long object wound into a roll. The printing medium 101 can be made of paper, plastic film, wood, cardboard, metal film, or the like.

The printing medium 101 is conveyed in the conveyance direction (X direction) by the conveyance unit 107. The conveyance belt 107a is a belt that rotates around a rotation axis extending in the depth direction (Y direction) that intersects with the conveyance direction, and is made of resin, metal or the like. The conveyance belt 107a is a suction conveyance belt configured to fix the printing medium 101 by suctioning through a number of holes opened in the belt with a suction pump installed inside the belt. A method of fixing and conveying the printing medium is not limited to the above-mentioned method of fixing and conveying the printing medium by suction. For example, a method of suctioning and conveying the printing medium with static electricity may be used. The method of fixing and conveying the printing medium 101 can be selected as appropriate depending on the system.

The arrows inside the conveyance unit 107 in FIG. 1 indicate the rotation direction of the conveyance belt 107a. The arrows outside the conveyance unit 107 in FIG. 1 indicate a conveyance path of the printing medium 101. The printing medium 101 is conveyed from the feeding unit 106 to the conveyance unit 107. In the printing unit 110, the printing head 102 applies the processing liquid and ink to the printing medium 101 on the conveyance unit 107 to form an ink image. The printing medium 101 with the ink image formed thereon is conveyed to the discharge unit 108 by the conveyance unit 107, and the conveyed printing medium 101 is stacked in the discharge unit 108.

### Printing Head

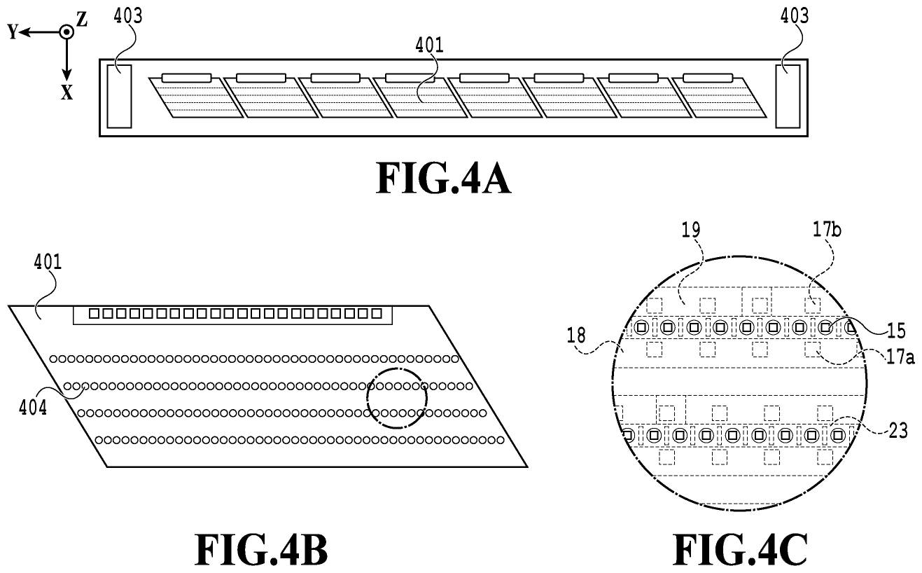

The printing head will be described below with reference to FIG. 1. The printing head 102 is a full-line head that extends in the paper width direction (Y direction). The printing head 102 has a plurality of ejection ports 404 (to be described in detail later with reference to FIGS. 4A to 4C) arranged in a range that covers the width of an image print region of the printing medium 101 of the maximum possible size. An ejection surface where the ejection ports are opened is provided on the lower surface of the printing head 102 in the gravitational direction (the printing medium 101 side). During printing on the printing medium 101, the ejection surface of the printing head 102 is fixed facing the printing medium 101 being conveyed (the conveyance unit 107) while maintaining a minute gap (about several millimeters) with the surface of the printing medium 101 being conveyed. The position of the printing head in this event will be referred to as a “printing position”.

As shown in FIG. 1, a plurality of printing heads are arranged along the conveyance direction (X direction) as the printing head 102. In this example, a first printing head that applies the processing liquid is provided on the upstream side of a second printing head that applies the ink. On the downstream side of the first printing head in the conveyance direction, four second printing heads are provided in order. These four second printing heads correspond to line-type printing heads for four colors, Bk (black), Y (yellow), M (magenta), and C (cyan). Note that the color types, the order of the colors, and the number of the colors are not limited to the example described here. The liquid ejected by the printing head 102 is supplied to the printing head 102 from an ink tank (not shown) through an ink tube.

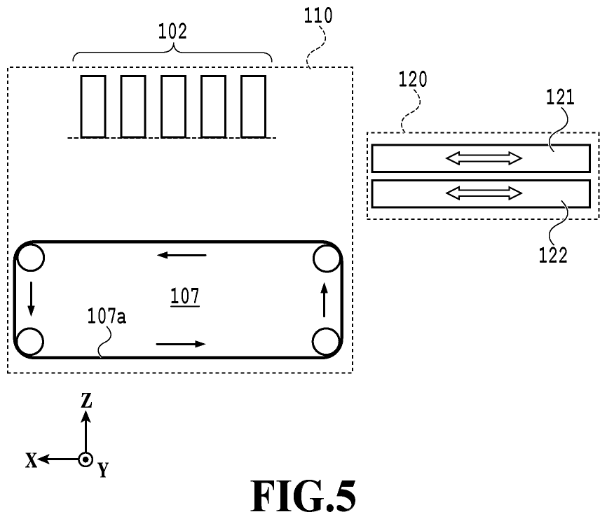

FIGS. 4A to 4C are diagrams explaining a structure of the printing head 102. FIG. 4A is a plan view showing the ejection surface of the printing head 102. FIG. 4A is a view of the printing head 102 as viewed from the-Z direction. As shown in FIG. 4A, in the printing head 102, a plurality of printing element substrates 401, each having a plurality of ejection ports 404 (FIG. 4B) for ejecting a liquid (processing liquid and ink) are aligned in the paper width direction (Y direction). At both ends of the row of the printing element substrates 401, positioning members 403 for the printing head 102 are also provided. The positioning members 403 are configured to be able to come into contact with an opposing printing head positioning member (not shown) provided on the opposing conveyance unit side. As this opposing printing head positioning member comes into contact with the positioning member 403, a distance between the ejection surface of the printing head 102 and the conveyance belt 107a can be determined. Similarly, various maintenance operations are appropriately performed by the positioning member 403 coming into contact with an opposing printing head positioning member (not shown) provided on the maintenance unit 120 side (to be described in detail later with reference to FIG. 5).

FIG. 4B is a schematic diagram of the printing element substrate 401 as viewed from the −Z direction. Here, the surface on which the ejection ports 404 are provided will be described as an upper surface. FIG. 4C is an enlarged view of a portion in FIG. 4B. The surface (ejection surface) of the printing element substrate 401 is made of resin. The printing element substrate 401 is provided with arrays of the plurality of ejection ports 404 for ejecting the liquid (processing liquid and ink) in a row. The plurality of ejection ports 404 are arranged along a direction (Y direction) orthogonal to the conveyance direction (X direction) of the printing medium 101. Any one row formed by the plurality of ejection ports 404 arranged in the Y direction will be referred to as an “ejection port array”. As shown in FIG. 4B, the plurality of ejection port arrays are arranged in the printing element substrate 401 so that their respective X direction positions are different. Specifically, four ejection port arrays are provided in the X direction, each array having 512 ejection ports arranged at 600 dpi (dots per inch). In addition, two adjacent ejection port arrays are arranged while being shifted by 1200 dpi in the Y direction. Under the resin part in which the ejection port arrays are formed, a pressure chamber 23 is provided for each ejection port 404 as shown in FIG. 4C. By controlling the pressure in the pressure chamber 23, the ink can be ejected from any ejection port 404.

The printing element substrate 401 is formed by laminating a silicon substrate made of Si and an ejection port forming member made of photosensitive resin. As shown in FIG. 4C, a printing element 15 is formed on one side of the silicon substrate, and a groove that constitutes a liquid supply path 18 and a liquid collection path 19, which extend along the ejection port array, is formed on the back side. A differential pressure is generated between the liquid supply path 18 and the liquid collection path 19. As printing is performed by ejecting the liquid from the plurality of ejection ports 404, the differential pressure causes a flow of the liquid in the ejection ports 404 not engaged in the ejection operation. Specifically, the liquid in the liquid supply path 18 provided in the silicon substrate flows to the liquid collection path 19 through a supply port 17a, the pressure chamber 23, and a collection port 17b. This flow can suppress an increase in viscosity of the liquid in the ejection port 404 and the pressure chamber 23 where the ejection of the liquid is stopped. This flow also allows the thickened ink, bubbles, foreign substances, and the like caused by evaporation from the ejection ports 404 to be collected to the liquid collection path 19. The printing head according to the present embodiment can thus suppress the increase in viscosity of the liquid in the vicinity of the pressure chamber 23 and the ejection ports 404. This makes it possible to prevent position errors in ejection and ejection failure, resulting in high-quality printing.

### Maintenance Unit

FIG. 5 is a schematic diagram of the printing unit 110, showing a state of the printing head in a standby period position. The “standby period position” corresponds to a standby position of the printing head in a case where no printing operation is performed. In the standby period position, the printing head 102 stands by in a position retracted upward in the gravitational direction from the printing position.

The printing head 102 can be moved to a maintenance position. The maintenance unit 120 is configured to be movable in a space extending below the printing head 102 in the standby period position in the gravitational direction. The “maintenance position” refers to a position in a state where the printing head 102 has moved downward in the gravitational direction from the standby period position so as to come into contact with the moved maintenance unit 120. In a case of performing capping of the printing head 102 after completion of printing, for example, the printing head 102 moves to the maintenance position. Also in a case where dust and the like adhere to the ejection surface of the printing head 102, causing liquid ejection failure, for example, the printing head 102 moves to the maintenance position for maintenance.

As the printing head 102 moves to the standby period position, a space is formed between the printing head 102 and the conveyance unit 107. This allows the maintenance unit 120, which is movable in the conveyance direction (X direction), to move to a position facing the printing head.

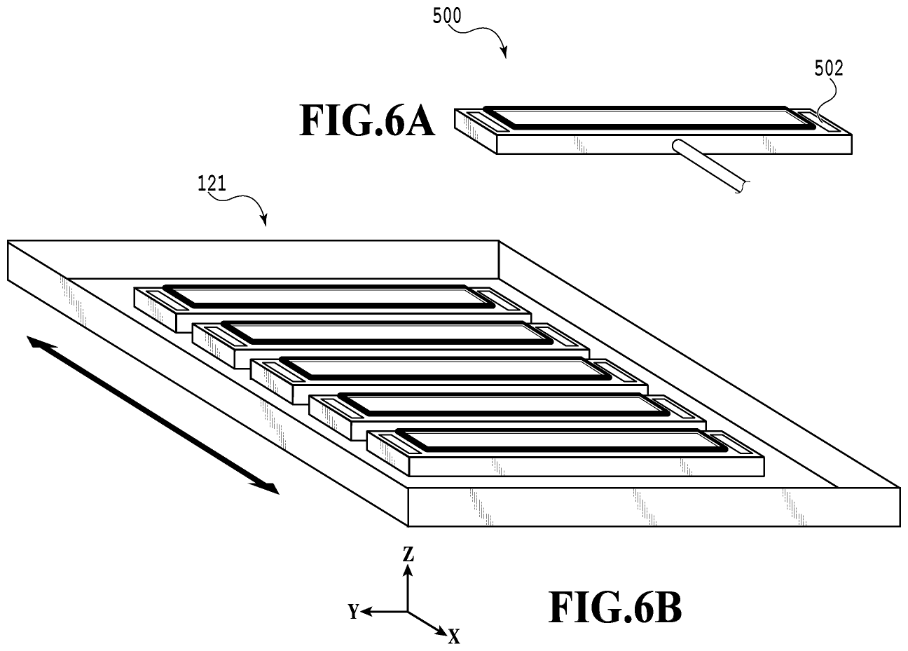

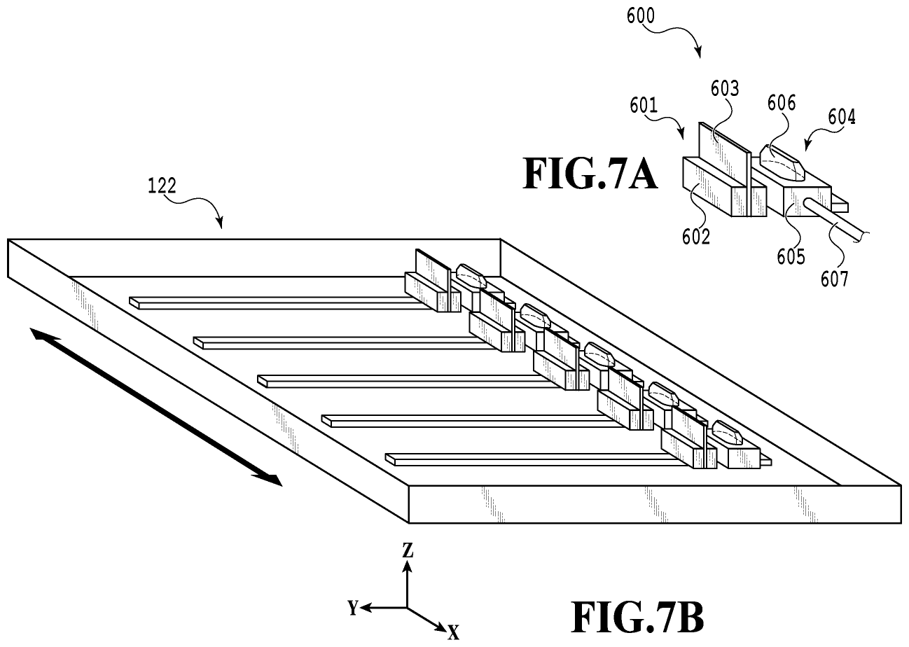

As shown in FIG. 5, the maintenance unit 120 includes a cap tray 121 for protecting the ejection surface (so-called capping) and a cleaning tray 122 for maintenance (also referred to as recovery processing) of the ejection surface. A plurality of cap mechanisms 500 are arranged in the maintenance unit 120 (see FIG. 6B). A plurality of cleaning mechanisms 600 are arranged in the cleaning tray 122 (see FIG. 7B).

The cap tray 121 and the cleaning tray 122 are configured to be movable in the apparatus longitudinal direction (X direction, the direction of the white arrows in FIG. 5) by a driving motor (not shown) and rails provided on a housing. In the present embodiment, five printing heads 102 are provided in total, and thus five capping mechanisms 500 and five cleaning mechanisms 600 are provided in total corresponding to the five printing heads 102.

The cap mechanism 500 needs to appropriately come into contact with the printing head 102 and is thus provided with opposing printing head positioning members 502 (see FIG. 6A). The opposing printing head positioning members 502 are disposed at the front and rear of the cap mechanism 500 in the sheet width direction (Y direction). Specifically, the opposing printing head positioning members 502 used for positioning one printing head 102 with respect to the cap mechanism 500 are disposed on the −Y direction side and +Y direction side of the cap mechanism 500, respectively. The printing head 102 and the cap mechanism 500 are positioned by the positioning members 403 (see FIG. 4A), which are provided at both ends of the printing head 102, coming into contact with the opposing printing head positioning members 502 of the cap mechanism 500. The cap mechanism 500 is positioned with respect to the printing head 102, and can thus protect the ejection surface of the printing head 102 and suppress water evaporation from a nozzle section.

FIG. 7B is a perspective view of the cleaning tray 122. As with the cap tray 121, the cleaning tray 122 includes a plurality of printing head positioning members (not shown) for positioning the plurality of printing heads 102. The positioning configuration is the same as that of the cap tray 121 described above, and thus description thereof will be omitted.

The positioning configuration is not particularly limited, and may be a configuration in which a part of the printing head 102 is butted against the inside of the cleaning tray 122, or a configuration in which positioning is performed using holes and pins provided in the cleaning tray 122 and the printing head 102.

As described above, five cleaning mechanisms 600 are provided in the cleaning tray 122 in the present embodiment, corresponding to the number of the printing heads 102 (five). As shown in FIG. 7A, each cleaning mechanism 600 includes a wiper portion 601 and a suction wiper portion 604.

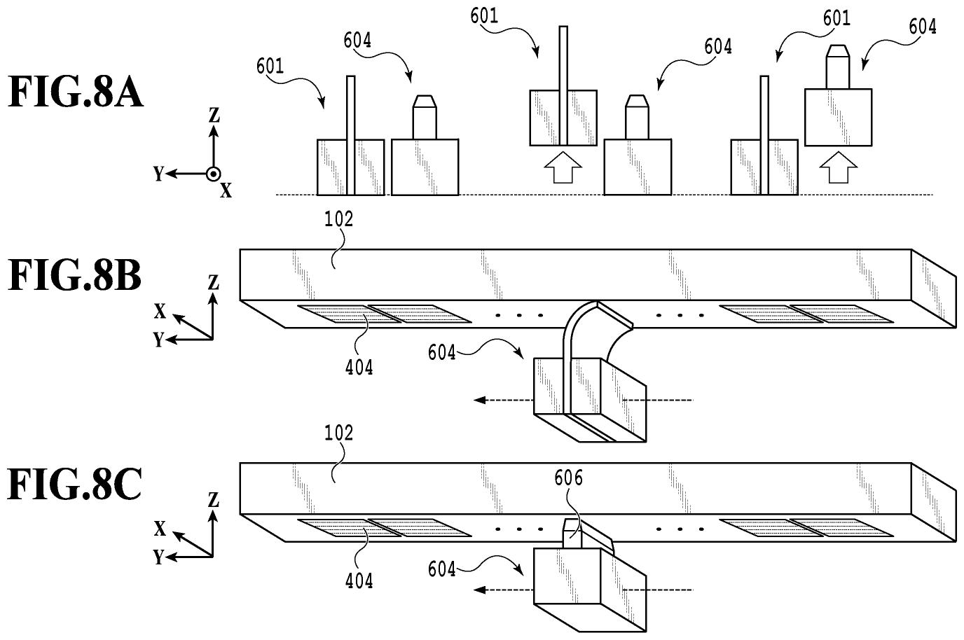

As shown in FIG. 8A, the wiper portion 601 and the suction wiper portion 604 can be elevated and lowered individually in the Z direction by a cam mechanism (not shown). By scanning in the array direction of the ejection ports 404 with the wiper portion 601 or the suction wiper portion 604 elevated, different recovery processes (recovery process by the wiper portion 601 and recovery process by the suction wiper portion 604) can be realized with the same driving source.

The wiper portion 601 is a member for wiping the ejection surface of the printing head 102, and has a flexible plate-shaped rubber blade 603 attached to a holder 602 (see FIG. 7A). As shown in FIG. 8B, the rubber blade 603 is pressed against the printing head 102 and brought into sliding contact with the surface of the ejection surface in the Y direction, thereby wiping off dust such as paper dust and ink droplets adhering to the vicinity of the ejection ports 404. In the present embodiment, the recovery process by the wiper portion 601 will be described as a “recovery process A (also referred to as a first recovery process)”.

The recovery process A by the wiper portion 601 is selectively executed based on the judgment of the user who has seen the state of an actually outputted printed product or the like. The recovery process A has the weakest recovery capability among the recovery process A and recovery processes B and C to be described later, and is always executable by the user.

The suction wiper portion 604 is a member that applies negative pressure to the ejection surface of the printing head 102 to wipe the ejection surface by suction. The suction wiper portion 604 has an elastic tube 606 fixed to the holder 605 and a suction tube 607 connected to the elastic tube 606 (see FIG. 7A).

The elastic tube 606 is formed to have dimensions that can cover the plurality of ejection ports 404 in the arranging direction (Y direction) of the ejection ports 404, and cover all the ejection port arrays in the direction (X direction) intersecting with the ejection port arranging direction. As shown in FIG. 8C, the open end of the elastic tube 606 is pressed against the ejection surface, and the ejection surface is moved in the Y direction while operating a suction pump (not shown) connected to the elastic tube 606 through the suction tube 607. The elastic tube 606 is thus brought into sliding contact with the entire ejection surface to perform suction and wiping simultaneously. Such suction wiping makes it possible to suction and remove dust such as paper dust adhering to the entire ejection surface including the vicinity of the ejection port 404, solidified and adhering ink, and air bubbles and thickened printing liquid present inside the ejection port 404 and the pressure chamber. In the present embodiment, the recovery process by the suction wiper portion 604 will be described as the “recovery process B (also referred to as a second recovery process).”

The recovery process B (also referred to as the second recovery process) by the suction wiper portion 604 has a stronger recovery effect than the recovery process A by the wiper portion 601, but also has a disadvantage of consuming more ink. Therefore, the recovery process B is selectively executed based on the judgment of the user who has seen the state of the actually outputted printed product.

### Kogation Removal Process and its Problem

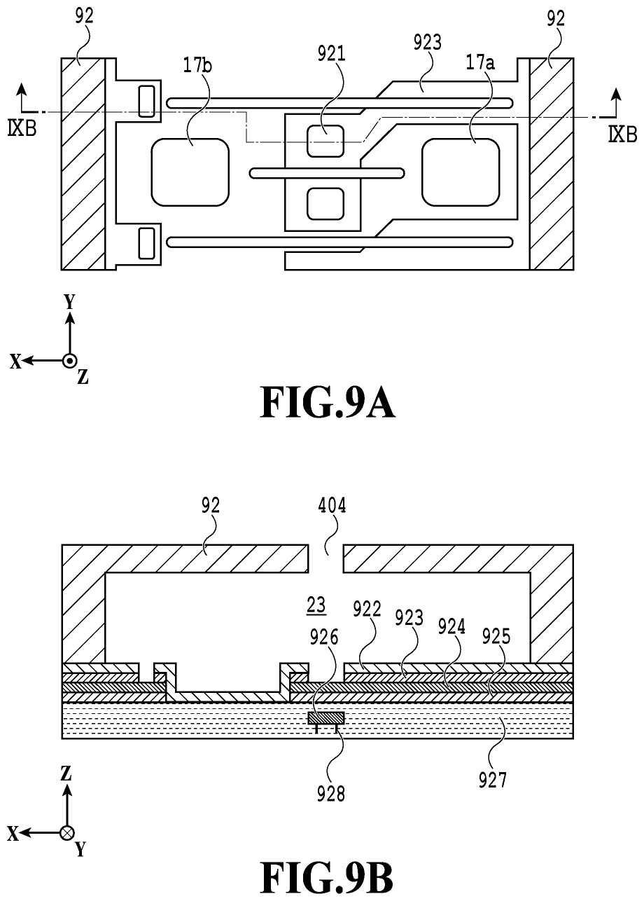

The structure of the heat acting portion in the printing element substrate 401 according to the present embodiment will be described below with reference to FIGS. 9A and 9B. FIG. 9A is an enlarged plan view schematically showing around the heat acting portion in the printing element substrate 401. FIG. 9B is a cross-sectional view taken along dashed line IXb-IXb in FIG. 9A.

In the printing head 102, the printing element substrate 401 is formed by laminating a plurality of layers on a base made of silicon. In the present embodiment, a heat storage layer made of a thermal oxide film, a SiO film, a SiN film or the like is disposed on the base. A heating resistor (heater) 926 that function as a printing element is disposed on the heat storage layer. An electrode wiring layer (not shown) that serves as wiring formed of a metal material such as Al, Al—Si or Al—Cu is connected to the heating resistor (heater) 926 through a tungsten plug 928. An insulating protection layer 927 is disposed on the heating resistor (heater) 926. The insulating protection layer 927 is an insulating layer provided on the heating resistor (heater) 926 so as to cover the heating resistor (heater) 926. The insulating protection layer 927 is formed of a SiO film, a SiN film or the like.

A protective layer for blocking contact with the liquid is disposed on the insulating protection layer 927. This protective layer is made of a lower protective layer 925, an upper protective layer 924, and an adhesive protective layer 923, and protects the surface of the heating resistor (heater) 926 from chemical and physical impact caused by heat generation by the heating resistor (heater) 926.

In the present embodiment, the lower protective layer 925 is made of tantalum (Ta), the upper protective layer 924 is made of iridium (Ir), and the adhesive protective layer 923 is made of tantalum (Ta). These protective layers formed of such materials have electrical conductivity. On the adhesive protective layer 923, a protective layer 922 is disposed for resistance to liquids and for improving adhesion to the ejection port forming member 92. The protective layer 922 is made of SiC. The upper protective layer 924 contains a metal that dissolves into the liquid due to an electrochemical reaction. The upper protective layer 924 is formed of a material that does not form an oxide film that prevents dissolution into the liquid through heating.

As the liquid is ejected, the upper part of the upper protective layer 924 is in contact with the liquid, and the liquid temperature rises instantaneously at the upper part, generating bubbles, followed by bubble dissipation, creating a harsh environment in which cavitation occurs. For this reason, in the present embodiment, the upper protective layer 924 made of an iridium material with high corrosion resistance and high reliability is formed at a position corresponding to the heating resistor (heater) 926 and is in contact with the liquid.

In the present embodiment, an ink circulation configuration is adopted in which the liquid is supplied through the supply port 17a and collected to the collection port 17b in the pressure chamber 23. Therefore, above the heating resistor (heater) 926 during printing, the liquid flows from the supply port 17a on the upstream side to the collection port 17b on the downstream side.

Furthermore, in the present embodiment, in a case where the upper protective layer 924 is made of iridium, a process is performed to remove kogation accumulated on the upper protective layer 924 of the heater. This process will be referred to as “kogation removal process” in the present embodiment. More specifically, an electrochemical reaction is caused by using a portion of the upper protective layer 924 directly above the heating resistor (heater) 926 as one of the electrodes 921, causing dissolution of the upper protective layer 924 into the ink. This makes it possible to remove the kogation accumulated on the upper protective layer 924. In this event, a potential of 4.0 V is applied to the electrode 921 for 30 seconds, causing the upper protective layer 924 to be dissolved by about 2 nm. However, there is no restriction on this condition and the amount of dissolution can be set arbitrarily. The kogation accumulated on the upper protective layer 924 is thus removed, resulting in a state where there is no kogation or less kogation on the heater surface layer. In the present embodiment, the kogation removal process will be described as the “recovery process C (also referred to as a third recovery process)”.

However, there is a problem that the number of times that the kogation removal process can be performed is limited depending on the remaining thickness of the layer that forms the upper protective layer 924 of the heater. The thickness of the upper protective layer 924 of the heater is about 40 nm, and the minimum thickness of the upper protective layer required to prevent the ink from penetrating the heater layer is 20 nm. Therefore, in a case where a layer of about 2 nm is dissolved as the kogation removal process is performed once, the number of times that the kogation removal process can be performed during the usable period of the printing head is limited to 10 times. It is difficult for the user to determine that a defective image is caused by heater kogation just by looking at the print result. The user may not be able to select an appropriate recovery process from among the plurality of recovery processes and may end up executing the kogation removal process. If the kogation removal process is thus performed at an inappropriate time or frequency, the number of times that the process can be performed, 10 times, will be consumed earlier than expected. As a result, the lifetime of the printing head will come to an end sooner than the expected usage period.

As the kogation removal process is executed, the upper protective layer 924 on the heater is dissolved, leaving no kogation on the surface layer. This is the same state as a brand-new printing head. To resume a normal printing operation, it is necessary to perform various adjustment sequences again, such as aging of the head, adjustment of landing positions of ejected ink, and correction of image unevenness, which are performed upon installation of a brand-new printing head. Since it often takes at least about several tens of minutes to perform such various adjustment sequences, this time period is a downtime of the printing apparatus during which the user cannot perform any printing operations. As for commercial and industrial printing apparatuses, in particular, there is a problem that this downtime may have a negative impact on the workflow, including the target number of prints for that day, the printing schedule, and back-end processes such as binding and shipping after printing.

### Execution of Kogation Removal Process

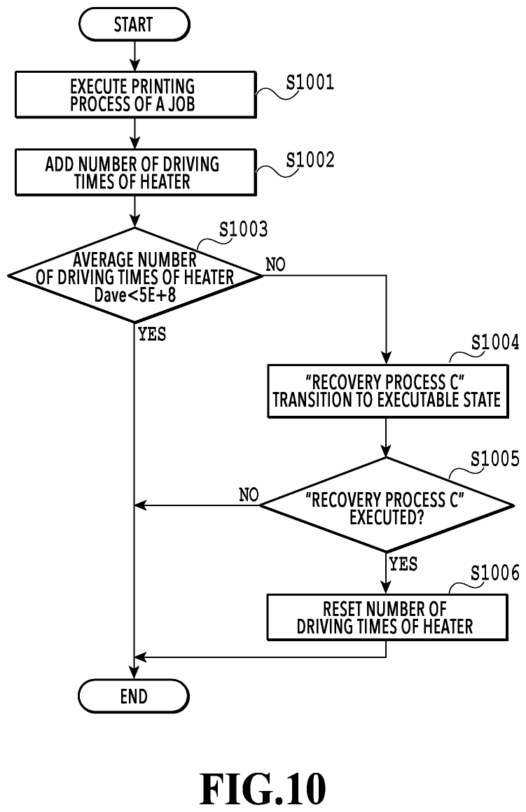

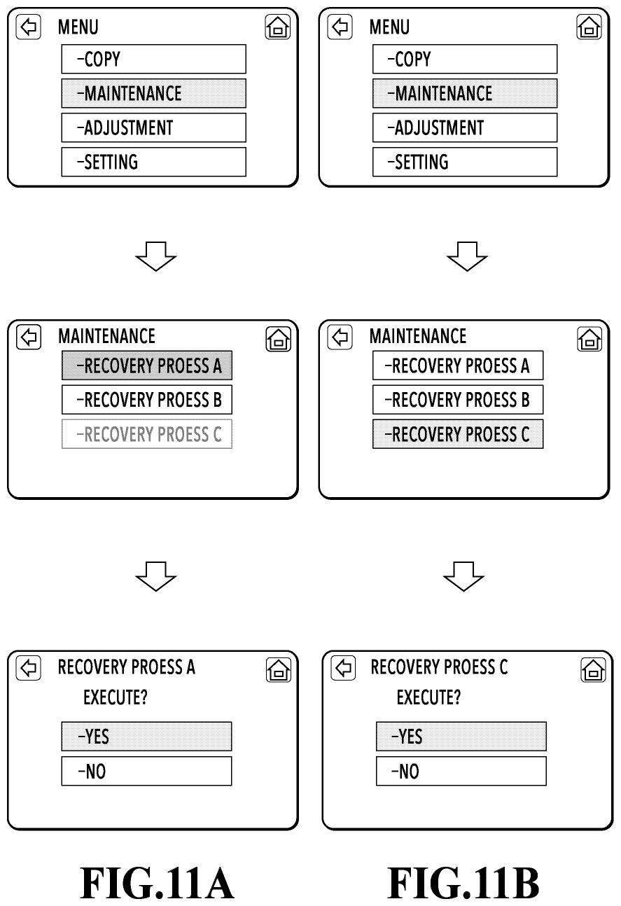

The execution of the kogation removal process (recovery process C) in the printing head 102 described above will be described below with reference to FIGS. 10, 11A, and 11B. FIG. 10 is a flowchart showing a series of processes including a judgment step for judging whether or not to make a transition to a state where the kogation removal process can be executed. The series of processes shown in the flowchart of FIG. 10 are performed by the CPU 304 expanding and executing a program code stored in the ROM 302 into the RAM 303. Alternatively, some or all of the functions of the steps in FIG. 10 may be implemented by hardware such as an ASIC or an electric circuit.

The number of times that the kogation removal process (recovery process C) can be executed has its limit (upper limit). Therefore, in the present embodiment, the number of driving times of the heater is used as information (estimation information) that can estimate the ejection state of the printing head, to determine whether or not to make a transition to the state where the kogation removal process can be executed, based on the estimation information. The reason for this is that the amount of kogation on the heater is proportional to the number of driving times of the heater, and it is known that the number of driving times of the heater affects the ejection state of the printing head (for example, a decrease in the ejection speed).

FIGS. 11A and 11B show screen transitions of a GUI screen displayed on the operation panel in a case of executing the recovery process for the printing head 102. In the present embodiment, description will be given of a case where the user instructs the execution of the maintenance process through the operation panel provided in the printing apparatus. Note that the menu configuration is not limited to that shown in FIGS. 11A and 11B, and is designed appropriately according to the system. An input unit used by the user is not limited to the operation panel (touch panel), and menu items can also be selected using physical keys, mouse operation, and the like.

The printing apparatus includes a count unit for counting the number of driving times of the heater in the printing head 102, corresponding to an image printed by print processing of a job, to obtain a count value. It is desirable to count the number of driving times of the heater for each individual heater, which, however, can increase the circuit scale for counting the number of driving times of the heater. Therefore, a plurality of heaters may be grouped, and the number of driving times of the heater may be counted for each group. In the present embodiment, the width direction of an image region to be printed is divided into rectangular regions of 16 pixels wide at 1200 dpi. Then, the plurality of heaters belonging to each region are grouped, and the number of driving times of the heater is counted for each group. The ejection ports are arranged at 600 dpi and form four ejection port arrays. Therefore, the number of driving times D of 32 heaters (=8 nozzles×4 ejection port arrays) is counted for one group. Since the number of driving times D cannot be specified for each of the 32 heaters, it is desirable to obtain an average number of driving times Dave of the heaters (=the number of driving times D of the heaters/32). The number of driving times of the heaters for each region is stored in a non-volatile memory provided in the printing apparatus 100 main body.

In step S1001, the CPU 301 of the printing apparatus 100 executes print processing of a job. Hereinafter, “step S” will be abbreviated as “S”.

In S1002, the CPU 301 uses the ASIC 304 to calculate the number of driving times of the heater associated with the execution of the print processing of the job, based on printing data generated by the printing data generation unit 201, and adds the calculated number of driving times of the heater to a variable of the average number of driving times Dave of the heater. This makes it possible to calculate the average number of driving times Dave of the heater after the execution of the print processing of the job.

In S1003, the CPU 301 determines whether the average number of driving times Dave of the heater calculated in S1002 is smaller than a predetermined threshold. If the determination result in this step is true, the series of processes ends. If the determination result is false, on the other hand, the processing proceeds to S1004. In the present embodiment, the predetermined threshold in this step is set to the number of driving times 5×10⁸ per heater, which corresponds to the number of driving times at which the ejection speed drops by about 2 m/s from the initial speed and begins to affect the image. This value may differ depending on the driving conditions of the printing head and the type of ink, and may be set appropriately depending on the system.

If the number of driving times of the heater is below the predetermined threshold (YES in S1003), it is estimated that the accumulation of kogation on the heater has not progressed and will not affect the ejection state. Therefore, in this case, the “recovery process C” remains in an inexecutable state (that is, the execution propriety parameter for the recovery process C is not updated). This is intended to prevent the inadvertent execution of the kogation removal process, “recovery process C”, since it is estimated that the number of driving times of the heater is small and that there is little kogation adhering to the heater.

Here, an example of the display transition on the GUI screen displayed on the operation panel constituting the operation control unit 202 (FIG. 3) in the state of YES in S1003 will be described with reference to FIG. 11A. First, the user selects “maintenance” from a menu screen 1101 on the operation panel. In FIG. 11A, a hatched button on the operation panel means that the button has been selected and executed. The downward arrows in FIG. 11A mean the transitions of the screen display as a result of the execution. Note that this expression rule also applies to the subsequent drawings.

As “maintenance” is selected, the GUI screen displayed on the operation panel transitions from the menu screen 1101 to a maintenance screen 1102. This leads to a state where any of the plurality of types of recovery processes to be executed by the plurality of types of recovery process units included in the printing apparatus can be selected. In this case, the recovery process A and the recovery process B are selectable. The recovery process C is grayed out and cannot be selected (the button for the recovery process C cannot be pressed). The user selects a recovery process according to the purpose.

For example, if fine stripes appear in the outputted image due to a small number of non-ejecting nozzles, it is highly likely that dust such as paper dust has adhered to the ejection surface of the printing head and is impeding the ink ejection. Therefore, wiping the ejection surface is an optimal process. In this case, the user therefore should select the “recovery process A” including the execution of wiping of the ejection surface.

As the user selects the “recovery process A” on the maintenance screen 1102, the GUI screen displayed on the operation panel transitions from the maintenance screen 1102 to a screen 1103 for the recovery process A. On the recovery process A screen 1103, the user is asked whether or not to execute the recovery process A. The recovery process A is executed as the user selects “Yes”. If the outputted image is partially faded or ejection failure is confirmed over a wide area, more powerful recovery process B may be selected.

Referring back to the description of FIG. 10, if the number of driving times of the heater is then greater than or equal to the predetermined threshold described above (NO in S1003), it is estimated that the accumulation of kogation on the heater is progressing and is beginning to affect the ejection state. Therefore, in S1004, the CPU 301 causes the recovery process C to transition to an executable state according to the user's intention. Specifically, the execution propriety parameter for the recovery process C is updated from a value indicating the inexecutable state to a value indicating the executable state. It is also possible to control the recovery process C to be executed automatically as the number of driving times of the heater reaches the predetermined threshold. However, as described above, the kogation removal process, the “recovery process C”, may cause downtime due to the execution of various adjustment sequences, resulting in a negative impact on the user's printing schedule. Therefore, the “recovery process C” needs to be executed according to the user's intention.

Here, an example of the display transition on the GUI screen displayed on the operation panel constituting the operation control unit 202 (FIG. 3) in the state of S1004 will be described with reference to FIG. 11B. First, the user selects “maintenance” from the menu screen 1104 on the operation panel. As “maintenance” is selected, the GUI screen displayed on the operation panel transitions from the menu screen 1104 to a maintenance screen 1105. In this event, the user can select from among the plurality of recovery processes that can be executed by the printing apparatus. In this example, the recovery processes A, B, and C are selectable. The user selects a recovery process according to the purpose. Although the recovery process C is selectable, the user does not necessarily have to select the recovery process C and can select any of the recovery processes according to his or her purpose.

As the user selects the “recovery process C” on the maintenance screen 1105, the GUI screen displayed on the operation panel transitions from the maintenance screen 1105 to a screen 1106 for the recovery process C. On the screen 1106 for the recovery process C, the user is asked whether or not to execute the recovery process C. If the user takes into consideration the downtime caused by executing the recovery process C and determines that the printing schedule for the day will not be affected, for example, during the lunch break or after work, the recovery process C is executed by selecting “Yes”.

Referring back to the description of FIG. 10, the CPU 301 determines in S1005 whether the recovery processing C has been executed, specifically, whether the selection of the “recovery processing C” by the user has been received through the maintenance screen 1105. If the determination result in this step is true, the processing proceeds to S1006. If the determination result in this step is false, on the other hand, the series of processes ends.

In S1006, the CPU 301 resets the number of driving times of the heater stored in the non-volatile memory of the printing apparatus 100 main body, that is, sets the number of driving times of the heater to zero. This step makes the “recovery process C” unselectable as shown in the maintenance screen 1102. With this configuration, the user will not inadvertently execute the kogation removal process, making it possible to prevent the lifetime of the printing head from being extremely shortened as a result of the kogation removal process, which can be executed for a limited number of times, being executed unnecessarily.

On the other hand, if the execution button (specifically, the “Yes” button on the recovery process C screen 1106) is not selected even though the recovery process C is selectable, the determination result in S1005 is NO and the series of processes ends. Therefore, in print processing of the next and subsequent jobs, the recovery process C will be displayed in an active (selectable) state on the maintenance screen until the recovery process C is executed. This makes it possible for the user to execute the recovery process C at any convenient time in the printing schedule. As a secondary effect, users who do not require extremely high image quality do not need to execute the recovery process C immediately even if the recovery process C becomes selectable. By executing the recovery process C when it is recognized that the image quality has deteriorated, the period until the kogation removal process is executed can be extended. This also makes it possible to extend the lifetime of the printing head.

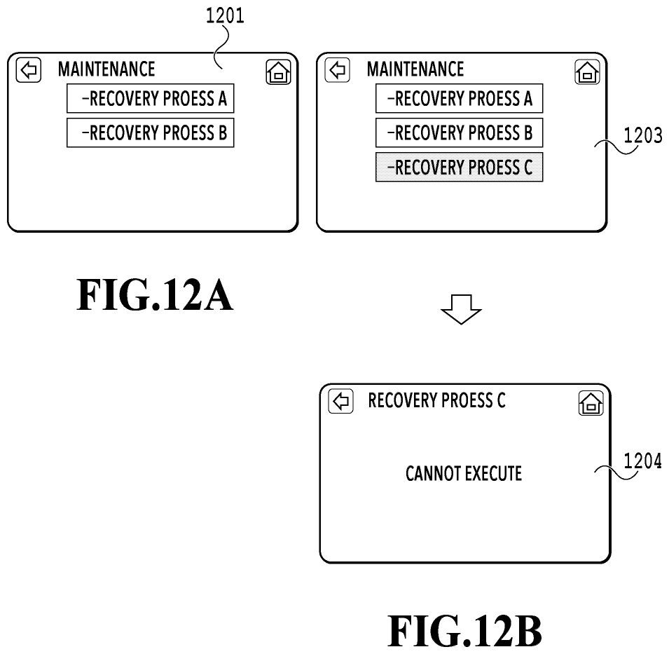

In the present embodiment, the recovery process C that cannot be executed is grayed out on the operation panel, but the means for switching between the executable state and inexecutable state of the recovery process C is not limited thereto, and should be designed appropriately according to the system. For example, as shown in a maintenance screen 1201 of FIG. 12A, the recovery process C may be made hidden in advance so that it cannot be selected. As also shown in a maintenance screen 1203 and a screen 1204 for the recovery process C in FIG. 12B, it is also possible to make a transition to a screen indicating that the recovery process C cannot be executed upon selection thereof even if the recovery process C is displayed in a selectable state. It is also possible to realize an inexecutable state by skipping the execution as an internal process (not shown) even if the recovery process C is displayed in a selectable state, and switching the operation after the execution instruction.

Once the recovery process C is executed, the surface layer of the heater part of the printing head is dissolved and returns to a brand-new condition. Therefore, various adjustment sequences are executed to resume printing. The various adjustment sequences include aging process of the printing head (aging ejection operation), registration adjustment, and head shading, which are intended to stabilize the ejection characteristics (for example, ejection speed) and correct the landing positions of ink droplets and image unevenness. These various adjustment sequences should be executed in conjunction with the execution of the recovery process C, since the ejection speed lowered by the removal of the kogation on the heater returns to its initial state, and the ejection characteristics and the landing positions of the ejected ink droplets change significantly before and after the execution of the recovery process C.

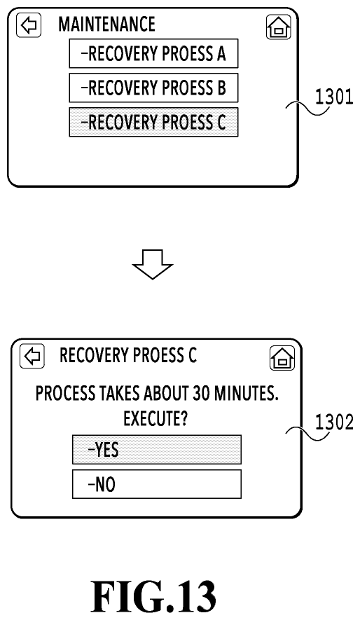

The execution of various adjustment sequences takes at least several tens of minutes. Once the user executes the recovery process C, a period during which printing cannot be performed, that is, downtime of the printing apparatus occurs. Therefore, as shown in a screen 1302 for the recovery process C in FIG. 13, an estimate of the time required for the recovery process C and operations associated therewith may be displayed, so that the user's intention to execute the process is confirmed before proceeding to the execution process.

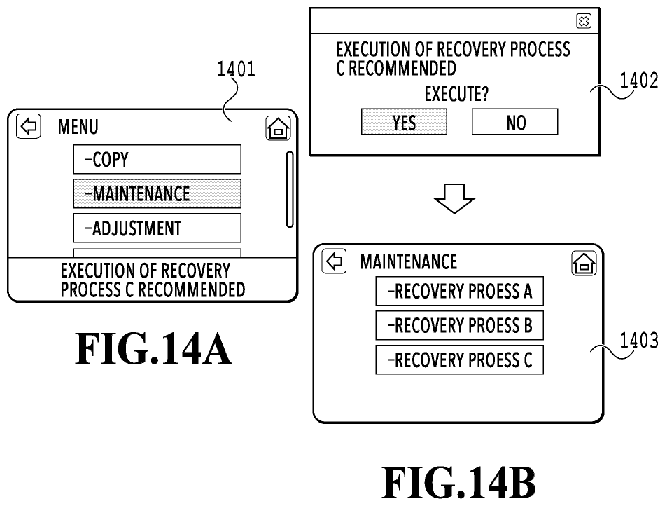

Since it is also difficult for the user to determine whether the number of driving times of the heater has reached the predetermined threshold or more, the user may not be able to recognize that the recovery process C is selectable on the maintenance screen. It is therefore desirable to adopt a configuration in which the user is notified that the recovery process C has transitioned to its executable state in S1004 of FIG. 10. As shown in a menu screen 1401 of FIG. 14A, for example, a configuration may be adopted in which the recovery process C has transitioned to its executable state and a message notifying that the execution of the recovery process C is recommended is displayed in part, thereby prompting the transition to the maintenance screen. As shown in FIG. 14B, a configuration may be adopted in which a pop-up screen 1402 is displayed on the operation panel, notifying that the recovery process C has transitioned to its executable state, and prompting a transition to a maintenance screen 1403 while confirming the intention to execute the process by having the user select “Yes” or “No”. As the user who has seen the pop-up screen 1402 selects “Yes”, the pop-up screen 1402 displayed on the operation panel disappears and the maintenance screen 1403 is displayed. Note that the recovery process C may also be executed by selecting “Yes”. It is also preferable to return to a home screen without executing any process by selecting “No” here. However, the present invention is not limited to the configurations described above, and any configuration may be adopted as long as the user can be notified that the recovery processing C has transitioned to its executable state.

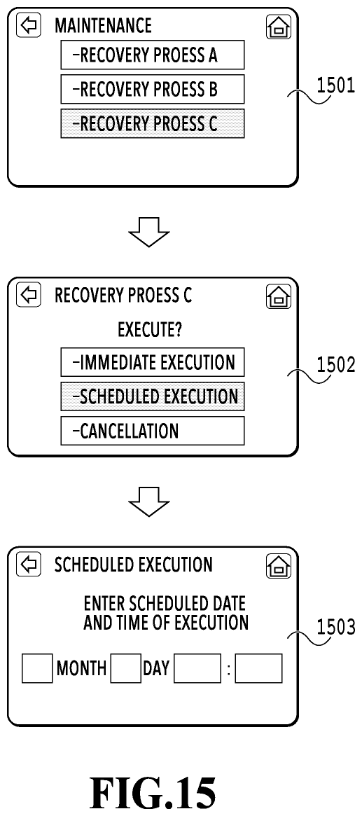

As a mode assuming a situation in which the user cannot immediately execute the recovery processing C, description will be given of a configuration having a mode in which the user can schedule the execution of the recovery process C in consideration of his/her own printing schedule by specifying a date and time of execution (this mode will be referred to as a scheduled execution mode). A maintenance screen 1501 of FIG. 15 is displayed after the “recovery processing C” as the kogation removal process has transitioned to its executable state. As the user who has seen the maintenance screen 1501 selects the recovery process C, the GUI screen displayed on the operation panel transitions from the maintenance screen 1501 to a screen 1502 for the recovery process C. The user can select immediate execution, scheduled execution or cancellation through the screen 1502 for the recovery process C.

Specifically, it is assumed that the user who has seen the recovery process C screen 1502 takes into consideration his/her own printing schedule and finds that the recovery process C cannot be executed immediately but can be scheduled for execution. As the user selects the scheduled execution (presses the “scheduled execution” button) in this situation, the GUI screen displayed on the operation panel transitions from the recovery process C screen 1502 to a scheduled execution screen 1503. Through this scheduled execution screen 1503, the user can input a convenient date and time, and the recovery process C and the adjustment sequence associated therewith will be automatically executed at the timing indicated by the input value. For example, by setting the execution date and time to a time during the lunch break or after work when the printing apparatus 100 is stopped, the execution of the recovery process C and the associated adjustment sequence can be instructed without affecting the printing schedule.

### Effects of Present Embodiment

According to the present embodiment, it is possible to realize the kogation removal process that does not affect the productivity or printing schedule while maintaining the lifetime of the printing head.

### Second Embodiment

In the first embodiment, (the count value of) the number of driving times of the heater is used as the estimation information for estimating the ejection state in order to make a transition to a state where the kogation removal process can be executed. This is because it is known that the kogation on the heater is accumulated in proportion to the number of driving times of the heater, affecting the ejection state (for example, reducing the ejection speed). However, the estimation information for estimating the ejection state is not limited to the number of driving times of the heater, and other parameters may be used. In the present embodiment, description will be given of a mode in which parameters other than the number of driving times of the heater is used as the estimation information for estimating the ejection state.

The minimum possible ejection voltage value may be used as the estimation information for estimating the ejection state. The minimum possible ejection voltage value refers to the minimum voltage value required for ink droplets to be ejected with respect to a reference ejection pulse. It is known that the kogation accumulated on the heater increases this minimum possible ejection voltage value. This is because the efficiency of heat transfer to the ink as the heater is driven decreases as the kogation is accumulated on the heater, resulting in an increase in the voltage value required for ink ejection. Therefore, by periodically measuring a change in the minimum possible ejection voltage value, the degree of kogation accumulated on the heater can be estimated, making it possible to indirectly estimate the ejection state of the printing head. For example, by making a transition to a state where the kogation removal process can be executed as the minimum possible ejection voltage changes by +0.8 V from the initial state, the same effect as that of the first embodiment can be achieved. The threshold used to determine whether or not to make the transition may be appropriately set based on the usage status of the printing head (environmental temperature and the like) and the combination of inks. For example, if the environmental temperature is higher than a predetermined temperature and ink that is prone to scorching is used, the threshold may be set low so as to correspond thereto.

The minimum possible ejection voltage can be detected by printing a predetermined pattern while gradually lowering the driving voltage, and measuring the driving voltage setting at which the pattern becomes faded and cannot be printed for the first time. In a case where the printing apparatus is equipped with an ejection detection device, such printing is not required, and the voltage value at the timing when the output from the ejection detection device changes from ejection to non-ejection can be measured while gradually lowering the driving voltage. The latter is a more preferable configuration because it does not use any printing medium (paper) and does not require analysis of a printed product.

For the same reason, the same effect can be obtained by using a minimum possible ejection pulse width with respect to the reference driving voltage.

The number of non-ejection heaters may also be used as the estimation information for estimating the ejection state. If the kogation continues to adhere to the heater, the efficiency of heat transfer to the ink as the heater is driven continues to decrease, and eventually the heater will be in a non-ejection state. Therefore, by periodically detecting the number of non-ejection heaters, the degree of kogation adhering to the heater can be estimated. This makes it possible to indirectly estimate the ejection state of the printing head. For example, as the number of non-ejecting heaters increases by +100 from the initial state, the same effect as that of the first embodiment can be achieved by making a transition to a state where the kogation removal process can be executed. The threshold used to determine whether or not to make the transition may be appropriately set based on the usage status of the printing head (environmental temperature and the like) and the combination of inks. For example, if the environmental temperature is higher than a predetermined temperature and ink that is prone to scorching is used, the threshold may be set low so as to correspond thereto.

The number of non-ejection heaters can be detected by printing a check pattern capable of distinguishing between ejection and non-ejection for each heater, and counting the number of missing heaters through analysis of a printed product. In a case where the printing apparatus is equipped with an ejection detection device, there is no need to print such a check pattern, and the number of non-ejection heaters may be detected by executing the ejection detection process for the entire printing head. The latter is a more preferable configuration because it does not use any printing medium (paper) and does not require analysis of the printed product.

By using position distribution information on the non-ejection heaters relative to the printing head, the ejection state can be estimated more accurately. For example, in a case where non-ejection heaters are distributed in one or more regions in isolation from each other, this is highly likely to be due to the adhesion of dust such as paper dust, which has temporarily caused the non-ejection. Therefore, no transition is made to the state in which the recovery process C can be executed. On the other hand, in a case where non-ejection heaters are concentrated in a specific region, it is highly likely that the non-ejection has occurred due to the adhesion of kogation on a more frequently driven heater as a result of repeated printing. Therefore, a transition is made to the state in which the recovery process C can be executed.

As the estimation information for estimating the ejection state, the density (information) of an output image may be used. The kogation adhering to the heater reduces the efficiency of heat transfer to the ink as the heater is driven, resulting in a state where the amount of ink droplets ejected decreases. Therefore, the degree of kogation adhering to the heater can be estimated by periodically detecting the density of the output image. This makes it possible to indirectly estimate the ejection state of the printing head. For example, the same effect as that of the first embodiment can be achieved by making a transition to a state where the kogation removal process can be executed at the timing when the brightness (information) has changed by a predetermined value or more. The threshold used to determine whether or not to make the transition may be appropriately set based on the usage status of the printing head (environmental temperature and the like) and the combination of inks. For example, if the environmental temperature is higher than a predetermined temperature and ink that is prone to scorching is used, the threshold may be set low so as to correspond thereto.

The density of the output image can be detected by printing an image pattern with a predetermined duty and obtaining an output value with a density detection device. If the printing apparatus is not equipped with the density detection device, it is also possible to scan the output, convert a signal value thereof to brightness, for example, and use the brightness as a substitute for the density.

A cumulative print count of the printing apparatus may be used as the estimation information for estimating the ejection state. Since the kogation on the heater is accumulated in proportion to the number of driving times of the heater, a rough correlation with the cumulative print count is known. Therefore, the degree of kogation adhering to the heater can be estimated based on the transition of the cumulative print count. This makes it possible to indirectly estimate the ejection state of the printing head. For example, by making a transition to the state where the kogation removal process can be executed at the timing when the cumulative print count exceeds two million, the same effect as that of the first embodiment can be achieved. The threshold used to determine whether or not to make the transition may be appropriately set based on the usage status of the printing head (environmental temperature and the like) and the combination of inks. For example, if the environmental temperature is higher than a predetermined temperature and ink that is prone to scorching is used, the threshold may be set low so as to correspond thereto. In a case where the printing apparatus is capable of conveying printing media of a plurality of sizes (including a predetermined first size), a print count of a printing medium of a size other than the first size may be converted, and the cumulative print count may be counted as the print count of the printing medium of the first size. For example, a case of a printing apparatus is considered where A3 size paper is conveyed in a vertical feed and A4 size paper is conveyed in a horizontal feed, and a print count of the A3 size paper and a print count of the A4 size paper are counted. In this case, with the cumulative print count =cumulative print count of A3 size paper×2+print count of A4 size paper, the print count of the A3 size paper can be treated as the print count converted to A4 size.

A cumulative printing time of the printing apparatus may be used as the estimation information for estimating the ejection state. Since the kogation on the heater is accumulated in proportion to the number of driving times of the heater, a rough correlation with the cumulative printing time is known. Therefore, the degree of kogation adhering to the heater can be estimated based on the transition of the cumulative printing time. This makes it possible to indirectly estimate the ejection state of the printing head. For example, by making a transition to the state where the kogation removal process can be executed at the timing when the cumulative printing time exceeds 1000 hours, the same effect as that of the first embodiment can be achieved. The threshold used to determine whether or not to make the transition may be appropriately set based on the usage status of the printing head (environmental temperature and the like) and the combination of inks. For example, if the environmental temperature is higher than a predetermined temperature and ink that is prone to scorching is used, the threshold may be set low so as to correspond thereto.

Information on a change in the number of non-ejection heaters after the execution of the recovery process may also be used as the estimation information for estimating the ejection state. In a case where the number of non-ejection heaters is reduced by executing the normal recovery processes (recovery process A and recovery process B) described in the first embodiment, the temporary non-ejection state is considered to be due to dust such as paper dust before execution of the normal recovery processes. In a case where the ejection failure is caused by kogation adhering to the heater, the number of non-ejection heaters should not change because the kogation cannot be removed even if the recovery processes A and B are executed. Therefore, the ejection state of the printing head can be estimated based on the change in the number of non-ejection heaters after the execution of the normal recovery processes. For example, in a situation where there are a predetermined number or more of non-ejection heaters, the same effect as that of the first embodiment can be achieved by making a transition to a state where the kogation removal process can be executed at the timing when the number of non-ejection heaters after the execution of the normal recovery processes no longer changes.

In the present embodiment, to make a transition to the state where the kogation removal process can be executed, information other than the number of driving times of the heater is used as the estimation information for estimating the ejection state. Specifically, the information includes the minimum possible ejection voltage value, the minimum possible ejection pulse width, the number of non-ejection heaters, the density of the output image, the brightness of the output image, the cumulative print count, the cumulative printing time, and the change information on the number of non-ejection heaters after the execution of the recovery process. By using any one of the information listed here, or a combination of some thereof, the same effect as that of the first embodiment can be achieved. Alternatively, a combination of two or more of the information listed here and the number of driving times of the heater may be used.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to realize a recovery process that prevents reduced lifetime of a printing head.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-040233, filed Mar. 14, 2024, which is hereby incorporated by reference wherein in its entirety.

What is claimed is:

1. A printing apparatus comprising:
a printing head having an ejection port for ejecting a liquid and a printing element for generating energy required to eject the liquid;
a plurality of recovery processing units that perform a recovery process for recovering an ejection state of the printing head, the recovery process including a first recovery process and a second recovery process;
a transition unit that causes the first recovery process to transition to an executable state, based on estimation information for estimating the ejection state; and
an operation control unit including an operation panel on which a GUI screen is displayed, wherein
the execution of the recovery process by the recovery processing unit is instructed by a user or a service person through the operation control unit, and
the second recovery process can be executed regardless of the estimation information.

2. The printing apparatus according to claim 1, wherein
the recovery process includes a first recovery process with a limited number of executions.

3. The printing apparatus according to claim 2, wherein
the first recovery process is a kogation removal process for removing kogation in the printing head.

4. The printing apparatus according to claim 1, wherein
the GUI screen selectively displays the plurality of types of recovery processes.

5. The printing apparatus according to claim 4, wherein
the GUI screen has a first button for selecting the first recovery process, and
the first button cannot be pressed with the first recovery process in an inexecutable state.

6. The printing apparatus according to claim 5, wherein
the GUI screen has a second button for selecting the second recovery process, and
the second button can be pressed with the first recovery process in the inexecutable state.

7. The printing apparatus according to claim 4, wherein
in a case where the first recovery process is inexecutable, the GUI screen does not have a first button for selecting the first recovery process, and
in a case where the transition unit causes the first recovery process to transition to an executable state, the first button is displayed on the GUI screen.

8. The printing apparatus according to claim 4, wherein
in a case where the first recovery process is inexecutable, the GUI screen has a first button for selecting the first recovery process, and
in a case where the first button is pressed as the first recovery process is inexecutable, the first recovery process is not executed.

9. The printing apparatus according to claim 1, wherein
the GUI screen includes a screen for displaying an estimate of the time required for the first recovery process and processing of an operation associated with the first recovery process.

10. The printing apparatus according to claim 1, wherein
the GUI screen includes a screen for recommending the execution of the first recovery process.

11. The printing apparatus according to claim 1, wherein
immediate execution, scheduled execution or cancellation of the first recovery process can be selected through the GUI screen.

12. The printing apparatus according to claim 11, wherein
in a case where the scheduled execution is selected, the first recovery process is executed at a specified time.

13. The printing apparatus according to claim 1, wherein the estimation information is any one of or a combination of some of information based on the number of driving times of a heater, a minimum possible ejection voltage value, a minimum possible ejection pulse width, the number of non-ejection heaters, a density of an output image, brightness of the output image, a cumulative print count, a cumulative printing time, and the number of non-ejection heaters after execution of a recovery process.

14. The printing apparatus according to claim 1, wherein
the plurality of types of recovery processes include a second recovery process that is always executable,
the plurality of types of recovery process units include a second recovery process unit that executes the first recovery process, and
the recovery process unit includes a wiper portion.

15. The printing apparatus according to claim 14, wherein
the plurality of types of recovery processes include a third recovery process,
the plurality of types of recovery process units include a third recovery process unit that executes the third recovery process, and
the third recovery process unit includes a suction wiper portion.

16. The printing apparatus according to claim 15, wherein
the plurality of types of recovery processing units include a first recovery processing unit that executes the first recovery process,
the first recovery processing unit includes the printing element and an upper protective layer disposed so as to be electrically connectable to serve as an electrode for causing an electrochemical reaction with the liquid in a region including the printing element,
the upper protective layer is formed of a material that contains a metal that dissolves due to an electrochemical reaction and does not form an oxide film that prevents the dissolution upon heating, and
the first recovery process is a process for removing kogation adhering to the printing element by causing an electrochemical reaction to dissolve a surface layer of the upper protective layer.

17. The printing apparatus according to claim 2, further comprising:
an execution unit that executes an adjustment sequence for the printing head as the first recovery processing is executed.

18. The printing apparatus according to claim 17, wherein
the adjustment sequence includes an aging ejection operation of the printing head, registration adjustment, and head shading.

19. A method for controlling a printing apparatus including a printing head having an ejection port for ejecting a liquid and a printing element for generating energy required to eject the liquid, a plurality of recovery processing units that perform a recovery process for recovering an ejection state of the printing head, the recovery process including a first recovery process and a second recovery process, a transition unit that causes the first recovery process to transition to an executable state, based on estimation information for estimating the ejection state; and an operation control unit including an operation panel on which a GUI screen is displayed, the method comprising:
a step of receiving the execution of the recovery process by the recovery processing unit, the execution is instructed by a user or a service person through the operation control unit, and wherein the second recovery process can be executed regardless of the estimation information.

20. A non-transitory computer readable storage medium storing a program for causing a computer to execute a method for controlling a printing apparatus including a printing head having an ejection port for ejecting a liquid and a printing element for generating energy required to eject the liquid, a plurality of recovery processing units that perform a recovery process for recovering an ejection state of the printing head, the recovery process including a first recovery process and a second recovery process, a transition unit that causes the first recovery process to transition to an executable state, based on estimation information for estimating the ejection state; and an operation control unit including an operation panel on which a GUI screen is displayed, the method comprinsing:
a step of receiving the execution of the recovery process by the recovery processing unit, the execution is instructed by a user or a service person through the operation control unit, and wherein the second recovery process can be executed regardless of the estimation information.
